(19) United States
(12) Patent Application Publication
(10) Pub. No.: US 2011/0226702 A1
(43) Pub. Date: Sep. 22, 2011

(54) Solubilized Heavy Metal Binding Reagent

(76) Inventor: Theodore Sall, Old Tappan, NJ (US)

(21) Appl. No.: 13/002,212

(22) PCT Filed: Jun. 30, 2009
(86) PCT No.: PCT/US2009/049315

§ 371 Date: Jun. 3, 2011

Related U.S. Application Data
(60) Provisional application No. 61/077,101, filed on Jun. 30, 2008.

(51) Int. Cl. B01D 21/01; C09K 3/00

(52) U.S. Cl. 210/723; 252/175

(57) ABSTRACT

A solubilized reagent for treating and binding heavy metals and method of producing and process of using the same. The solubilized reagent includes an isolated supernatant of a slurry or a saturated or supersaturated solution of alkali metal/alkaline earth metal carbonate, alkali metal/alkaline earth metal sulfide, and triple super phosphate.

### FIELD OF INVENTION

The present invention relates to compositions and methods for remediating heavy metals.

### BACKGROUND OF THE INVENTION

Heavy metals, such as arsenic, cadmium, chromium, copper, gold, iron, lead, nickel, silver, tin, and zinc, are ubiquitous in modern industrial products and processes, and even some consumer products. For many applications, no suitable alternatives exist. Unfortunately, in their elemental and/or ionic forms, heavy metals can be highly toxic to humans and animals.

Heavy metals are discharged into the environment in contaminated soil, dust, paint residue, wastewater, and other forms. For example, wastewater associated with plating, metal surface treatment, semiconductor manufacture, incineration residue treatment, and other processes often contains heavy metals. For environmental, public health, and economic reasons, there is, therefore, a very compelling need for efficient and safe methods for recovering heavy metals and remediating them by rendering them substantially unleachable.

Traditional methods of treating wastewater streams that contain different metal contaminants involve multiple processes. For example, a metals-laden wastewater stream requires removal of the metal precipitates by multiple cycles of pH adjustment and extraction, as each metal may have a unique, pH-dependent precipitation threshold. Other methods involve binding the heavy metals into a complex; yet fail to provide a simple way to recover the metals. The costs associated with converting hazardous waste to non-hazardous materials for proper disposal are enormous, particularly if no means is provided for reclaiming the metals.

Solucorp Industries (West Nyack, N.Y.) offers products and processes for remediating heavy metals in wastewater and other media. The technology called “Molecular Bonding System™” or “MBS™” utilizes powdered, chemical agents mixed with water to form a slurry, which can be added to wastewater, soil, or other medias contaminated with heavy metals. The MBS™ technology remediates the heavy metals by converting them to substantially insoluble metal sulfides. While the MBS™ process offers substantial savings on cleanup costs because the contaminated water need not be transported off site for treatment or disposal as hazardous waste, the metallic sulfides are bound with or mixed in with the MBS™ granules, making it difficult to isolate the metal sulfides and reclaim the metals. It is therefore desirable to have a system that remediates heavy metals and facilitates metal recycling. Such a system would reduce landfill waste and offset the costs of remediation, and provide additional economic value.

### BRIEF DESCRIPTIONS OF DRAWINGS

Various aspects, features, and embodiments of the invention will become more clear when considered in light of the appended drawings, wherein:

FIGS. 1A-B are photographs of a slurry of a MBS™ remediation agent and an extract (supernatant) thereof. The extract (supernatant) shown in FIG. 1B corresponds to Example 1 of the present invention. FIG. 1C shows a picture of the extract of FIG. 1B after a second extraction;

FIG. 2A is a picture of two coins prior to treatments. FIG. 2B is a photograph of the coin after being treated with a heavy metal remediation reagent according to an embodiment of the present invention. FIG. 2C is a photograph of the coin after being treated with a slurry of a MBS™ remediation agent or the prior art;

FIG. 3A is a picture of two coins prior to treatments. FIG. 3B is a photograph of the coin after being treated with a heavy metal remediation reagent according to one embodiment of the present invention. FIG. 3C is a photograph of the coin after being treated with another heavy metal remediation reagent according to another embodiment of the present invention.

FIGS. 4A-C are photographs of the resulting reactions of various heavy metal remediation reagents according to different embodiments of the present invention challenged with an amount of lead nitrate;

FIGS. 5A1-7 are photographs of the resulting reactions of a heavy metal remediation reagent according to one embodiment of the present invention with lead nitrate solutions at various concentrations;

FIGS. 5B1-6 are photographs of test tubes containing various concentrations of lead nitrate solutions being treated with a heavy metal remediation reagent according to an embodiment of the present invention.

FIGS. 5C1-2 are photographs of test tubes containing the resulting supernatant of the example shown in FIG. 5A3 treated with lead nitrate and a fresh amount of a heavy metal remediation reagent according to an embodiment of the present invention, respectively;

FIGS. 5D1-2 are photographs of test tubes containing the resulting supernatant of the example shown in FIG. 5B3 with lead nitrate and a fresh amount of a heavy metal remediation reagent according to another embodiment of the present invention, respectively;

FIGS. 6A1-2 are photographs of two metallic copper strips after being treated with water and a heavy metal remediation reagent according to an embodiment of the present invention;

FIG. 6B is a photograph of two copper coins after being exposed to a heavy remediation reagent according to an embodiment of the present invention;

FIGS. 6C1-4 are photographs of test tubes containing various concentrations of copper sulfate solutions being treated with a heavy metal remediation reagent according to an embodiment of the present invention;

FIGS. 7A1-2 are before and after photographs of a metallic lead piece being treated with a heavy metal remediation reagent according to one embodiment of the present invention;

FIGS. 7B1-5 are photographs of test tubes containing various concentrations of lead nitrate solutions being treated with a heavy metal remediation reagent according to an embodiment of the present invention;

FIGS. 8A-D are photographs of a reaction sequence of a mercury globe being treated with a heavy metal remediation reagent according to one embodiment of the present invention;

FIGS. 8E1-5 are photographs of plastic cups containing various concentrations of ionic mercury solutions being treated with a heavy metal remediation reagent according to an embodiment of the present invention;

FIGS. 9A-D are photographs of test tubes containing various concentrations of antimony oxide solutions being treated with a heavy metal remediation reagent according to an embodiment of the present invention;

FIGS. 10A-D are photographs of test tubes containing various concentrations of chromium oxide solutions being treated with a heavy metal remediation reagent according to an embodiment of the present invention;

FIGS. 11A-D are photographs of test tubes containing various concentrations of cobalt sulfate solutions being treated with a heavy metal remediation reagent according to an embodiment of the present invention; and

FIGS. 12A-D are photographs of test tubes containing various concentrations of iron sulfate solutions being treated with a heavy metal remediation reagent according to an embodiment of the present invention.

### SUMMARY OF THE INVENTION

In one aspect, the invention provides a solubilized, heavy metal binding reagent that includes an isolated supernatant of a mixture of alkali metal/alkaline earth metal carbonate, alkali metal/alkaline earth metal sulfide, and triple super phosphate. In one embodiment, the mixture is a saturated or supersaturated solution. In one embodiment the mixture is a slurry.

In another aspect, the invention provides a method of making a solubilized heavy metal binding reagent, the method comprising forming an aqueous slurry of alkali metal/alkaline earth metal carbonate, alkali metal/alkaline earth metal sulfide powder, and triple super phosphate; forming a first supernatant by allowing the slurry to settle; and collecting the first supernatant.

In one embodiment, the method further comprises forming a second supernatant of a saturated or supersaturated solution of alkali metal/alkaline earth metal carbonate, alkali metal/alkaline earth metal sulfide, and triple super phosphate; and mixing the second supernatant with the first supernatant to form a final supernatant mixture.

In another aspect, the invention provides a method of using the reagent by contacting the reagent with a media that is or may be contaminated with heavy metals and/or heavy metal ions. The media can be a hard surface, a porous surface, or a liquid, such as a quantity of contaminated water. The reagent can also be used for spot testing a contaminated water source, and including treating the contaminated water source.

As used herein, the term “supernatant” or “supernatant of a solution” means the liquid that lies above a layer of sediment or precipitate. The terms “extract” means the supernatant that has been decanted or filtered, and is substantially free of precipitates.

Also, the term “alkali metal/alkaline earth metal carbonate” means one or more alkali metal carbonates and/or alkaline earth metal carbonates. The term “alkali metal/alkaline earth metal sulfide” means one or more alkali metal sulfides and/or alkaline earth metal sulfides.

### DETAILED DESCRIPTION

The present invention relates to a solubilized, heavy metal binding reagent, and a method of making the reagent. The solubilized, heavy metal binding reagent can be used to remove dissolved heavy metals from, e.g., a contaminated water stream or an aqueous industrial wastewater such as, industrial plating rinse waters, metal deburring waste water, electronic circuit board wastewater, and pharmaceutical wastewater.

In a first aspect, the invention provides a solubilized, heavy metal binding reagent comprising an isolated supernatant of a solution of alkali metal/alkaline earth metal carbonate, alkali metal/alkaline earth metal sulfide, and triple super phosphate. In one embodiment, the solution is a saturated solution. In another embodiment, the solution is supersaturated. In yet another embodiment, the supernatant is isolated from a slurry of alkali metal/alkaline earth metal carbonate, alkali metal/alkaline earth metal sulfide, and triple super phosphate.

Nonlimitting examples of alkali metal and alkaline earth metal carbonates include calcium carbonate and magnesium carbonate. Nonlimitting examples of alkali metal and alkaline earth metal sulfides include calcium sulfide, magnesium sulfide. Thus, in an exemplary embodiment, the reagent comprises an isolated supernatant of a calcium carbonate, calcium sulfide, and triple super phosphate solutions (hereinafter “solubilized reagent” or “reagent”).

Powdered, heavy remediation agents are available from Solucorp Industries, and are sold as “MBS™” products. Preferred remediation agents comprise mixtures of technical grade calcium sulfide, calcium phosphate or triple super phosphate. “Triple super phosphate” (also referred to as tri-super phosphate, or TSP) is P₂O₅.

In some embodiments, the solubilized reagent includes extracts of one or more additional agents to enhance the overall heavy metal remediation effectiveness, and/or to act as pH buffers. Nonlimitting examples of suitable agents include calcium phosphate, magnesium phosphate, di-calcium hydrogen phosphate, calcium di-hydrogen phosphate, calcium hydroxide, calcium oxide, calcium carbonate, magnesium hydroxide, magnesium oxide, magnesium carbonate, apatite, dolomite, phosphoric acid, and/or mixed calcium adducts of these agents.

Other examples of remediation agents include phosphoric acid and its salts, which can be used for lead abatement; the mineral apatite (Ca₅(PO₄)₃(F, Cl, OH); alkaline earth silicates (e.g., calcium silicate), which operate through absorption and as a consequence of their high alkalinity (hence, their effect is likely not permanent); hydrated silica and hydrated alumina; and metal-absorbing clays, such as Bentonite and Fuller's Earth. While these compounds can be used in various combinations to bind heavy metals, in some embodiments, it is preferred to use agents having the same cations (e.g., Ca²⁺, Mg²⁺, etc.). For example, if calcium sulfide is used magnesium carbonate is preferably not used in lieu of calcium carbonate. Similarly, magnesium oxide is preferably not used to replace calcium oxide if calcium sulfide is employed.

In one embodiment, the solubilized reagent includes calcium carbonate, calcium sulfide, and triple super phosphate at a weight ratio of about 0.01:0.27:10.00 and is capable of reacting almost instantaneously with a 2 wt % solution lead nitrate. The solubilized reagent has a clear color, with a pH of about 11.5 and a specific gravity of about 1.02. In some embodiments, the solubilized reagent can remediate heavy metals under varying pH conditions ranging from alkaline to acidic.

In various embodiments, the reaction of the solubilized reagent is faster than the conventional MBS™ aqueous suspension or slurry. For example, when copper coins were exposed to a solution of solubilized reagent, a layer of copper sulfide was deposited on the surface of the coins within 3 minutes. The layer of the copper sulfide deposit was sufficiently dense that the copper color and the embossed features on the coin were obliterated. In contrast, copper coins exposed to conventional MBS™ slurry took longer for a layer of copper sulfide to develop. After 3 minutes of exposure, the embossed features and copper color of the coins were still visibly seen.

The solubilized reagent can be used in various applications by contacting the reagent with a media that is or may be contaminated with heavy metals or heavy metal ions. For example, the solubilized reagent can be sprayed on a surface, a hard surface, or a non-porous surface such as floors, carpeted or concrete floors, walk ways, or drive ways. When the solubilized reagent contacts the heavy metals, either in their elemental or ionic states, the solubilized reagent reacts with the heavy metals rendering them non-hazardous in non-leachable forms. In certain embodiments, the reaction renders the heavy metals and heavy metal ions to be present in their metal sulfide state. In this way, the metal sulfide can be collected for recycling or ore smelting to reclaim the metal for its economic value.

In addition, the solubilized reagent can be used to treat contaminated water. In certain embodiments, a heavily contaminated media or water source is treated with a solubilized reagent first to remove the metal sulfide prior to subjecting the contaminated media to traditional remediation methods. In this way, the insoluble metal sulfide can be obtained and disposed of as non-hazardous waste without contributing to the bulk of the sludge or hazardous material. Alternatively, the insoluble metal sulfide can be recycled or smelted to extract the valuable metallurgy.

In certain embodiments, the solubilized reagent is used to test water for the presence of heavy metals and/or heavy metal ions. In one embodiment, the solubilized reagent is used as a spot test indicator for heavy metal contaminants. For example, the presence of heavy metals and/or heavy metal ions can be detected by placing a small amount of solubilized reagent in a container filled with the suspected water. If there is a formation of precipitate, the suspected water is most likely contaminated with heavy metals and/or heavy metal ions. The contaminated water then can be treated with the solubilized reagent or an augmented solubilized reagent, which will be further discussed below, and/or by other means.

In a second aspect, the present invention provides an augmented solubilized heavy metal binding having increased remediation power. This is accomplished by increasing the concentrations of carbonate, sulfide, and triple super phosphate components. In one embodiment, a remediation reagent supplement is prepared and then added to the solubilized reagent to form an augmented solubilized reagent.

In one embodiment, the remediation reagent supplement is a mixture of supernatants separately prepared from, respectively, an alkali metal/alkaline earth metal carbonate (e.g., calcium carbonate, an alkali metal/alkaline earth metal sulfide (e.g., calcium sulfide), and triple super phosphate. The three supernatants are combined to form the remediation agent supplement. Of course, supernatants of other remediation agents can also be used so long as they can increase the concentrations of the agents in the original solubilized reagent. Details and methods of preparing the remediation reagent supplement will be further discussed below.

In one embodiment, both the solubilized reagent and the remediation reagent supplement have the same weight concentration of each remediation agent (e.g., 0.0105% calcium carbonate, 0.2700% calcium sulfide, and 10.0000% triple super phosphate). However, when an amount of the remediation reagent supplement is added to the solubilized reagent, the overall concentrations of the remediation agents in the solution are noticeably increased. In one embodiment, an addition of 20 vol % of the remediation reagent supplement to the solubilized reagent increases the concentrations of calcium carbonate, calcium sulfide, and triple super phosphate in the final solution by 62%, 26%, and 5%, respectively.

In one embodiment, the augmented reagent has a remediation agent supplement:augmented reagent volume ratio ranging from about 1:1 to about 1:5. In another embodiment, the augmented reagent has a remediation agent supplement:augmented reagent volume ratio of 1:4.

In one embodiment, the augmented reagent contains triple super phosphate at a concentration of about 10 wt % or more. In another exemplary embodiment, the augmented reagent has a calcium carbonate:calcium sulfide:triple super phosphate ratio of about 0.02:0.34:10.50 (wt/wt/wt). In the exemplary embodiment, the augmented reagent has a pH of about 12, a specific gravity of about 1.02, and can react instantaneously with a solution of 2 wt % lead nitrate forming lead sulfide.

The augmented reagent can be used to treat a source that is heavily contaminated with heavy metals. The augmented reagent causes the heavy metals and heavy metal ions to form metallic sulfides, which are substantially insoluble in water and solvents. In this way, the metal sulfides can be collected and removed from the contaminated source. In some embodiments, the contaminated source is repeatedly treated with the augmented reagent until the source is free of heavy metals.

In certain embodiments, the augmented reagent has the greatest reactivity with heavy metals, followed by the solubilized reagent, and remediation agent supplement. The produced particulates or sediments of these decanted solutions can be disposed as non-hazardous waste or in accordance with local or other appropriate regulations. In various embodiments, sediments that demonstrate some reactivity can be reused with a MBS™ slurry.

In another aspect, the invention provides methods of preparing a solubilized reagent, a remediation agent supplement, and an augmented solubilized reagent.

In one embodiment, the solubilized reagent is formed by obtaining an extract of a slurry containing MBS™ remediation agent. The slurry is formed by mixing an amount of MBS™ remediation agent with water.

In one embodiment, the MBS™ remediation agent comprises a 1:1 wt/wt blend of alkali metal/alkaline earth metal carbonate and alkali metal/alkaline earth metal sulfide. In another embodiment, the MBS™ remediation agent comprises a 3:8 to 3.8.5 wt/wt blend of triple super phosphate and alkali metal/alkaline earth metal sulfide.

In another exemplary embodiment, the MBS™ remediation agent is a 8:8:3 (wt/wt/wt) mixture of calcium carbonate, calcium sulfide, and triple super phosphate. The MBS™ remediation agent is not pH-dependent, and can remediate various heavy metals over a wide pH range.

In one embodiment, the MBS™ remediation agent is mixed with water at a weight ratio about 1:2. Higher or lower amounts of the MBS™ remediation agent and water can be used so long as a suspension of granulates in water is observed. In one embodiment, the slurry is allowed to settle until a supernatant phase is formed. The slurry can also be centrifuged to facilitate the formation of the supernatant. The supernatant is then isolated from the particulates either by decanting or filtration to form a solubilized reagent.

A remediation reagent supplement can be prepared by mixing a supernatant of each of the alkali metal/alkaline earth metal carbonate, alkali metal/alkaline earth metal sulfide, and triple super phosphate slurry, or saturated or supersaturated solutions. In one embodiment, the remediation reagent supplement has about 105 ppm alkali metal/alkaline earth metal carbonate by weight, about 0.27 wt % alkali metal/alkaline earth metal sulfide, and about 10 wt % triple super phosphate.

In an exemplary embodiment, the remediation reagent supplement comprises the supernatants of the calcium carbonate solution, calcium sulfide solution, and super phosphate solution. Although a slurry, a saturated, or a supersaturated solution of a remediation agent can be prepared, excess use of the remediation agent can be costly. Accordingly, in one embodiment, each solution is prepared based on the solubility characteristic of the remediation agent at room temperature. For example, if calcium carbonate is used, only 1.53 mg is used for every 100 ml of water because calcium carbonate has a lower solubility threshold than other remediation agents. Of course, a higher amount of calcium carbonate can be used to form a saturated solution. The mixture of calcium carbonate is allowed to settle and the liquid lying above the precipitate is filtered to obtain a calcium carbonate saturated solution. Similarly, solutions of calcium sulfide and triple super phosphate are prepared based on their solubility characteristics and filtered to obtain the respective saturated solutions.

In one embodiment, the calcium carbonate, calcium sulfide, and super phosphate supernatants are mixed at a volume ratio of about 2:2:1 to obtain a remediation reagent supplement having a clear color. In another embodiment, the supernatant of the super phosphate is diluted 20 times with water prior to mixing with the rest of the supernatants.

The remediation reagent supplement is then added to the solubilized reagent to form an augmented solubilized reagent. The augmented reagent is clear in color and substantially free of particulates. In one embodiment, the augmented reagent has a remediation agent supplement:solubilized reagent volume ratio ranging from about 1:1 to about 1:5. In another embodiment, the augmented reagent has a remediation agent supplement:solubilized reagent ratio of 1:4 (vol/vol).

According to various aspects of the present invention, both the solubilized reagent and the augmented reagent can be used to transform in heavy metals, either in their elemental or ionic state, to non-hazardous and substantially non-leaching forms. They can be used by themselves or in conjunction with a MBS™ slurry or other remediation agents when a media is heavily contaminated with heavy metals. In one embodiment, the solubilized reagent or the augmented reagent is used first to gather the heavy metals in insolubilized forms, such as metal sulfides so that they can be collected for recycling or smelting. The uncollected portion of the media is then further treated with additional solubilized reagent and/or augmented solubilized reagent, or other remediation agents as needed.

The following are nonlimiting examples of various embodiments of the inventions.

### Comparative Example A

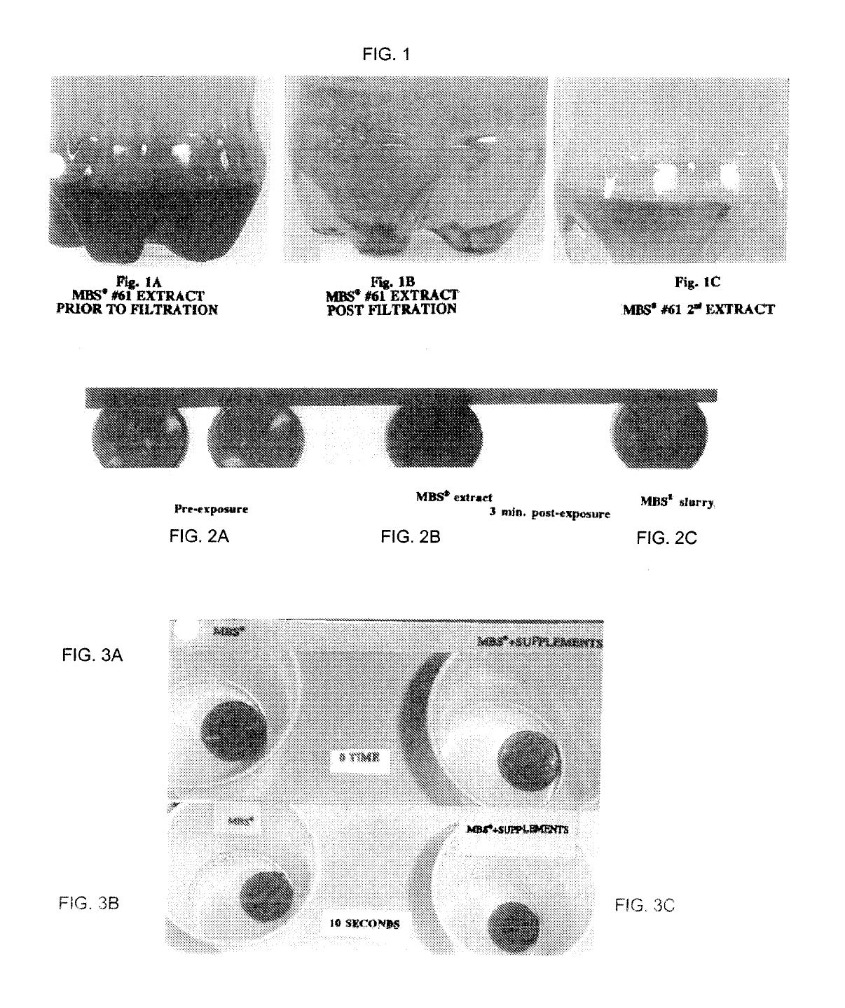

100 gram of MBS™ powder (a 8:8:3 wt/wt/wt blend of calcium carbonate, calcium sulfide, and triple super phosphate) was mixed with 200 ml of water to form a viscous slurry having a dark muddy color (FIG. 1A).

### Example 1

### Solubilized Reagent

A slurry of MBS™ powder prepared as in Comparative Example A was mixed vigorously in a blender for 2 minutes at slow speed, followed by another minute at high speed. The slurry mixture was transferred to a covered glass container and allowed to remain in a quiescent state until the particulates settled forming a sediment phase and a supernatant phase. The supernatant (comprising solubilized MBS™ powder) was separated from the sediment by decanting the supernatant on a filter paper (Fisher® brand). The supernatant appeared as a clear liquid with a green/yellow hue (FIG. 1B), and had a pH value of 11.5, a refractive index of 2.6, and a specific gravity of 1.015. The supernatant was odor free and had a calcium carbonate:calcium sulfide:super triple phosphate ratio of 0.01:0.27:10 (wt/wt/wt).

When 10 ml of 2% lead nitrate was introduced to 0.5 ml of the supernatant, the supernatant reacted almost instantaneously with the aliquot forming a precipitate of lead sulfide, which was allowed to settle. A second supernatant was obtained by re-extracting the original MBS slurry in the same fashion as described above. This second supernatant appeared clear and colorless (FIG. 1C), and did not react when challenged with additional 2% lead nitrate.

### Example 2

### Augmented Solubilized Reagent

A. Preparation of Remediation Agent Supplement

A saturated solution of aqueous calcium carbonate was prepared by adding 1.53 mg of calcium carbonate in 100 ml water. Similarly, saturated solutions of aqueous calcium sulfide and triple super phosphate were prepared by adding 12.1 mg of calcium sulfide in 100 ml of water, and 31.6 mg of super phosphate in 100 ml of water, respectively. The supernatant of each solution was obtained by allowing the solutions to settle and decanting the liquid phase. The supernatant of the saturated solution of super phosphate was diluted 20 times with water to obtain a diluted supernatant. The supernatants of the calcium carbonate, calcium sulfide and the diluted supernatant of triple super phosphate were mixed together at a weight ratio of 2:2:1 to obtain a supplement supernatant (“remediation agent supplement”) that was clear, colorless, and odor-free with a pH value of 11.8, a refractive index of 2.8, and a specific gravity of 1.0145. The remediation reagent supplement contained a calcium carbonate:calcium sulfide:triple super phosphate weight ratio of 0.0105:0.2700:10.0000.

B. Preparation of Augmented Solubilized Reagent

An augmented reagent was prepared by mixing the isolated solubilized reagent from Example 1 (80% by vol.) with the remediation reagent supplement (20% by vol.).

The augmented reagent was clear, of a green and yellow hue, odor-free, and had a pH value of 12, a refractive index of 2.1, and a specific gravity of 1.02, with a calcium carbonate:calcium sulfide:triple super phosphate ratio of 0.017:0.340:10.500 (wt/wt/wt).

Tests

1. Reaction with Metallic Copper

Two relative new and shiny copper coins were cleaned and placed in separate containers. 10 ml of comparative Example A was poured in the container containing the first coin to cover its top surface. Similarly, 10 ml of Example 2 was poured in the container containing the second coin to just cover its top surface. After 3 minutes, the coins were taken out for observation. As can be seen in FIG. 2C, the first coin has only a thin layer of copper sulfide deposited on the top surface. The embossed features and copper color of the coin can still be seen. In contrast, the second coin, FIG. 2C, has a thick layer of copper sulfide deposited on its surface. The copper sulfide layer is sufficiently thick that the copper color and the embossed features on the coin cannot be seen.

A similar experiment was conducted to compare Example 1 (solubilized reagent) with Example 2 (augmented solubilized reagent). The coins were observed after 10 seconds of exposure to the supernatants. As can be seen in FIG. 3C, the coin that was treated with the supernatant of the Example 2 (augmented solubilized reagent) has a thick layer of copper sulfide deposited on its surface. The embossed features of the coin cannot be seen, and very little copper color is seen. In contrast, the coin treated the supernatant Example 1 (solubilized reagent) still exhibits embossed features, as well as the copper color, of the coin (FIG. 3B). This experiment indicates that the augmented reagent (Example 2) reacts much more rapidly than the supernatant of solubilized reagent (Example 1).

2. Reaction with Lead Nitrate

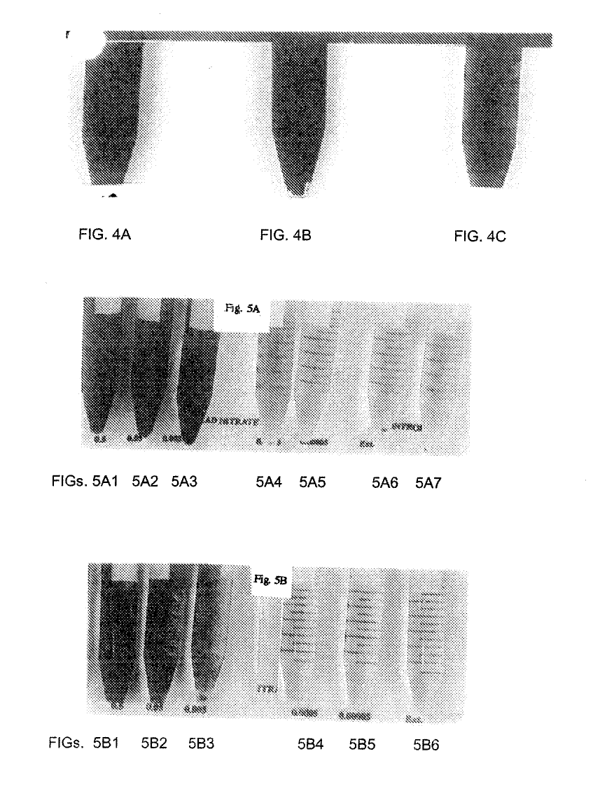

FIG. 4 shows a number of test tubes containing black suspension of lead sulfide formed by the reaction of various formulations prepared from the MBS™ powder with lead nitrate. FIG. 4A shows the resulting reaction of 10 ml of the supernatant of augmented reagent (prepared as in Example 2) with 1 ml 0.2 wt % lead nitrate. Similarly, FIGS. 4B and 4C show the resulting reaction of 1 ml of 0.2 wt % lead nitrate with 10 ml of the supernatant of solubilized reagent (Example 1) and remediation reagent supplement (prepared as in Example 2, Part. A), respectively. As can be seen, the supernatants of FIGS. 4A & B reacted readily with lead nitrate and formed a black suspension of lead sulfide. In contrast, the tube containing the supernatant of the remediation reagent supplement (Example 2, Part. A) and lead nitrate only shows a non-uniform and less dense suspension (FIG. 4C).

3. Reaction of Augmented Reagent with Lead Nitrate

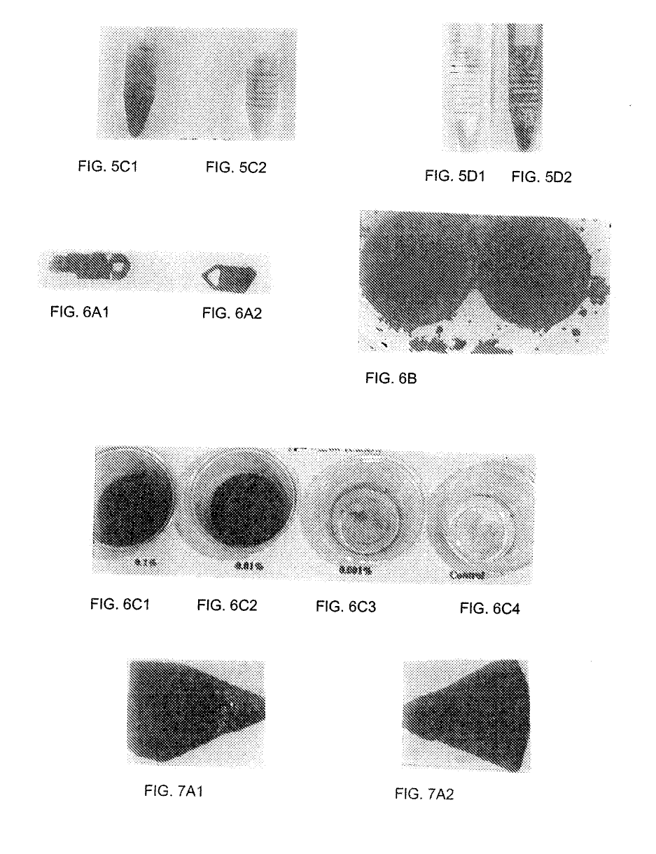

FIGS. 5A1-7 show the results of the reaction of various concentrations of lead nitrate challenged with 1 ml aliquot of the augmented reagent (Example 2). Each tube contained 10 ml of a specified concentration of lead nitrate and was treated with 1 ml of the augmented reagent (Example 2). The concentrations are presented in Table 1.

TABLE 1

| | 10 ml of lead | Augmented | |
|---|---|---|---|
| FIG. | nitrate (at wt %) | Reagent | Water |
| 5A1 | 0.5 | 1 ml | |
| 5A2 | 0.05 | 1 ml | |
| 5A3 | 0.005 | 1 ml | |
| 5A4 | 0.0005 | 1 ml | |
| 5A5 | 0.00005 | 1 ml | |
| 5A6 | | 1 ml | 10 ml |
| 5A7 | 0.5 | | 1 ml |

As can be seen, dense black suspensions of lead sulfide appeared in tubes 5A1-5A3, which contained 0.5-0.005 wt % of lead nitrate, respectively. At a lead concentration of about 0.0005 wt %, no such dense black suspension was formed, and the reaction resulted in only a slight color change. At a concentration of about 0.00005 wt %, no discernable suspension was detected (FIG. 5A5). As seen in FIG. 5A6, the control test tube containing 10 ml of water and 1 ml of the augmented reagent is clear and has no suspension. Similarly, in the control test tube of FIG. 5A7, which contains 10 ml of 0.5 wt % lead nitrate and 1 ml water, no suspension was noted.

4. Reaction of Solubilized Reagent with Lead Nitrate

In another experiment, the test described above were repeated using 1 ml aliquots of solubilized reagent, prepared as in Example 1. Each test tube contained 10 ml of lead nitrate at a given concentration and 1 ml of the solubilized reagent. The concentrations are presented in Table 2.

TABLE 2

| | 10 ml of lead | Solubilized | |
|---|---|---|---|
| FIG. | nitrate (at wt %) | Reagent | Water |
| 5B1 | 0.5 | 1 ml | |
| 5B2 | 0.05 | 1 ml | |
| 5B3 | 0.005 | 1 ml | |
| 5B4 | 0.0005 | 1 ml | |
| 5B5 | 0.00005 | 1 ml | |
| 5B6 | | 1 ml | 10 ml |

As can be seen, dense black suspension appeared in the tubes containing 0.05 to 0.005 wt % lead nitrate, and a scarcely noticeable suspension was formed in the tube containing 0.0005 wt % lead nitrate (FIG. 5B4). Again, the control which is shown in FIG. 5B6 produces no suspension of lead sulfide. The results confirm that the reactivity of the supernatant of augmented reagent (Example 2) is more reactive than the solubilized reagent (Example 1).

5. Reactivity of the Reacted Augmented Reagent (of Test No. 3)

The supernatant of the resulting reaction of FIG. 5A3 above (10 ml of 0.005 wt % lead nitrate treated with 1 ml of the augmented solubilized reagent) was isolated and placed in two test tubes. FIG. 5C1 shows the result of the reaction of a 4 ml aliquot of the isolated supernatant with 0.5 ml of 0.5 wt % lead nitrate. As can be seen, the supernatant of the previously reacted augmented reagent (Example 2) still reacted with the lead nitrate and formed a dense suspension of lead sulfide. The test result indicates that the reaction took place in FIG. 5A3 was complete and there was still an excess of the augmented reagent (Example 2), and hence it was able to react with the fresh amount of lead nitrate.

Similarly, 4 ml aliquot of the isolated supernatant obtained from the previous reaction of FIG. 5A3 is placed in another test tube. To the same test tube, 0.5 ml of the augmented reagent (Example 2) was added and the result of the reaction is shown in FIG. 5C2. As can be seen in FIG. 5C2, the test tube is clear and has no sign of suspension. The absence of a reaction indicates the original reaction was complete.

6. Reactivity of the Reacted Solubilized Reagent (of Test No. 4)

The tests described above were repeated using the supernatant of the reacted solubilized reagent (Example 1). FIG. 5D1 shows a test tube containing 4.0 ml aliquot of the supernatant produced from the reaction in the test tube of FIG. 5B3 (10 ml of 0.005 wt % lead nitrate treated with 1 ml of the solubilized reagent) and 0.5 ml of 0.5 wt % lead nitrate. As can be seen in FIG. 5D1, the aliquot remained clear with no sign of lead sulfide suspension. The result indicates that there was no remaining solubilized reagent (Example 1) from the prior reaction to react with the fresh addition of lead nitrate.

FIG. 5D2 shows a test tube containing a 4.0 ml aliquot of the supernatant produced from the reaction in the test tube of FIG. 5B3 and with an additional 0.5 ml of solubilized reagent (Example 1). As can be seen, a black suspension was produced. The presence of the suspension indicates that the original reaction was incomplete because the 1 m aliquot of the original solubilized reagent (Example 1) was insufficient to fully react with the lead nitrate. Hence, an additional amount of the solubilized reagent was needed to complete the reaction.

The two above experiments further confirm that the augmented reagent (Example 2) performs better than the solubilized reagent (Example 1).

Additional experiments were conducted using the augmented reagent (Example 2) with either elemental metals (metals in their metallic state) or as water soluble salts (metals in their ionic state). Control reactions were either pre-treatment (0 time) or similar samples in water.

7. Reaction with Metallic Copper

FIGS. 6A1 and 6A2 show the resulting reaction of elemental metal copper with the augmented reagent (Example 2). A strip of metallic copper was submerged in 10 ml of water and another strip was submerged in 10 ml of the augmented reagent (Example 2) for 30 minutes. As can be seen in FIG. 6A2 the copper strip that was submerged with the augmented reagent is covered with a dark layer of copper sulfide. In contrast, the strip submerged in water remained shinny and retained its original coating surface.

FIG. 6B shows a photograph of two coins post exposure to an augmented reagent according to an embodiment of the present invention. The coins were submerged in 20 ml solution of the augmented reagent for 48 hours. After 48 hours, it was noted that pieces of copper sulfide were cast off. This result indicates that the reagent continued to react with the exposed copper surface, resulting in marked corrosions of the coins.

8. Reaction with Copper Sulfate

FIGS. 6C1-3 show the results of reactions of soluble copper sulfate at various concentrations with the augmented reagent (Example 2). In each container, 5 ml of a specified concentration of copper sulfate was provided with an addition of 0.1 ml of the augmented solubilized reagent. The concentrations are presented in Table 3. Note that there is a slight sign of copper sulfide with the 0.001% solution (FIG. 6C3), whereas the control (FIG. 6C4) has no grey colored suspension because it was not treated with the augmented solubilized reagent.

TABLE 3

| | 5 ml of copper | Augmented |
|---|---|---|
| FIG. | sulfate (at wt %) | Solubilized Reagent |
| 6C1 | 0.1 | 0.1 ml |
| 6C 2 | 0.01 | 0.1 ml |
| 6C 3 | 0.001 | 0.1 ml |
| 6C 4 | 0.1 | (0.1 ml water) |

9. Reaction with Metallic Lead

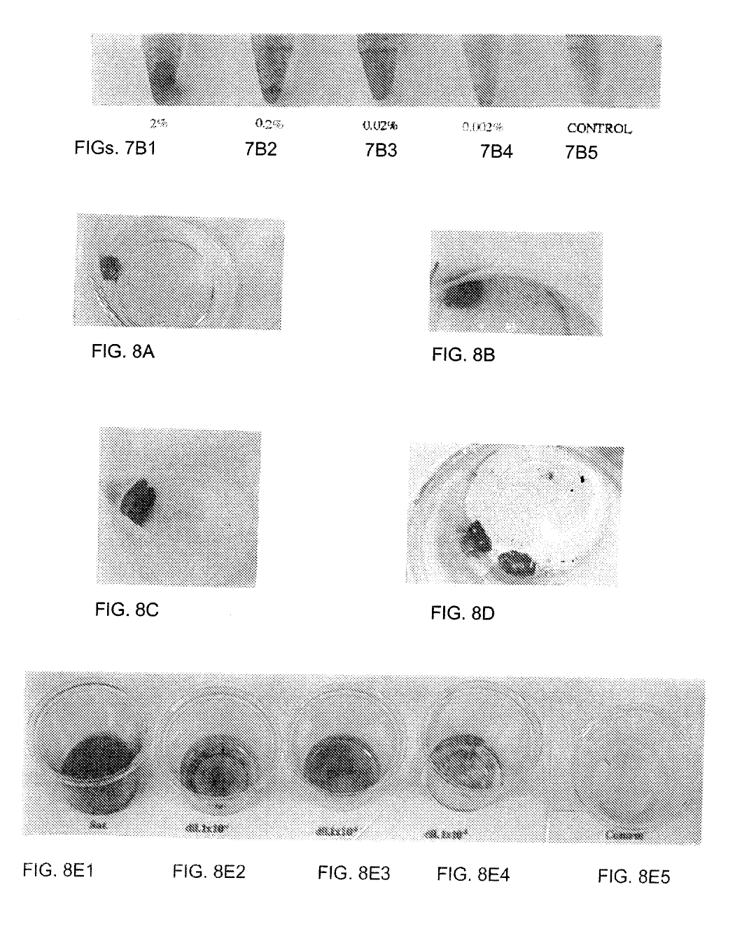

FIGS. 7A1-2 show the result of the reaction of a metal lead piece with the augmented solubilized reagent. A discolored lead piece was scored to produce shiny marks, which is noted as the “0 time control” (FIG. 7A1). After submerging the lead piece in 10 ml of the augmented reagent it was noted that the shiny marks began to tarnish within a minute. After 10 minutes the marks were completely indistinguishable from the surrounding surface.

10. Reaction with Lead Nitrate

FIGS. 7B1-4 show the results of reactions of various concentrations of lead nitrate challenged with an aliquot of the augmented solubilized reagent. Each tube contained 5 ml of a specified concentration of lead nitrate and was treated with 0.1 ml of the augmented reagent (Example 2). The concentrations are presented in Table 4.

TABLE 4

| | 5 ml of lead | Augmented |
|---|---|---|
| FIG. | nitrate (at wt %) | Solubilized Reagent |
| 7B1 | 2 | 0.1 ml |
| 7B2 | 0.2 | 0.1 ml |
| 7B3 | 0.02 | 0.1 ml |
| 7B4 | 0.002 | 0.1 ml |
| 7B5 | 2 | (0.1 ml water) |

It was noted that in all test tubes except for the control, the solution reacted instantaneously with the augmented reagent forming dark precipitates.

11. Reaction with Elemental Mercury

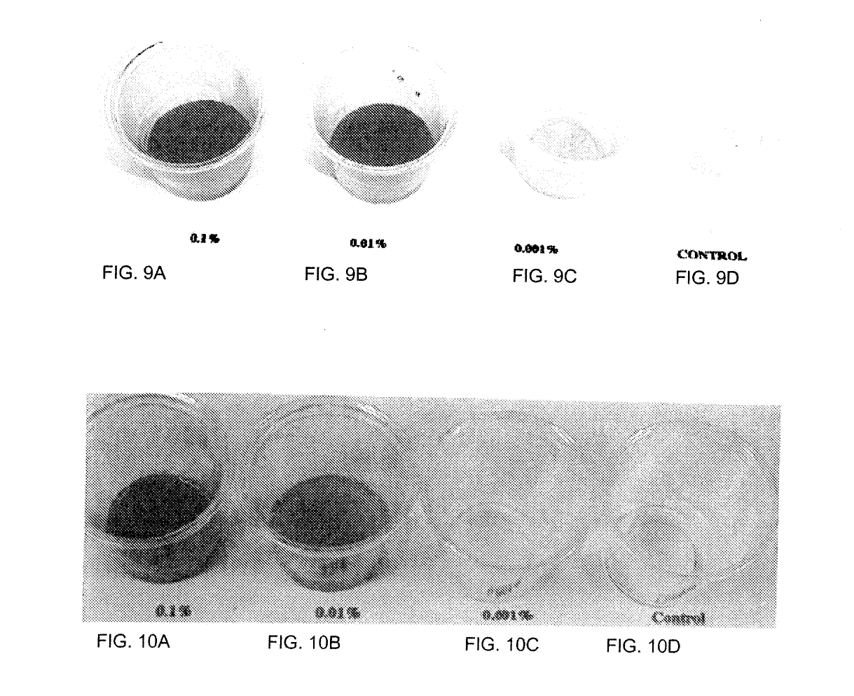

FIGS. 8A-D depict the reactions of elemental mercury with the augmented reagent conducted at various stages. A globule of mercury was submerged in a container supplied with 10 ml of augmented reagent (FIG. 8A). After 2 minutes, the silver shiny surface turned to a dark gray veneer (FIG. 8B). After 10 minutes, the globule of mercury turned dark black and assumed an oblong configuration (FIG. 8C). After 24 hours of exposure, the augmented reagent was decanted and the black colored mercury (mercury sulfide) was rinsed 5 times with distilled water. The oblong globule covered with the mercury sulfide surface was then jostled with a wooden probe causing a small globule of shiny mercury to be released and leaving behind a shell of mercury sulfide (FIG. 8D). The released globule was treated with fresh augmented reagent and the reaction sequence was repeated three additional times. Following the third treatment, elemental mercury did not appear when the oblong globule when its mercury sulfide surface was disrupted. This indicates that the elemental mercury was completely converted to mercury sulfide.

12. Reaction with Ionic Mercury

FIGS. 8E1-5 show the results of various concentrations of mercury sulfate [Hg₂SO₄] treated with the augmented solubilized reagent, prepared as in Example 2. FIG. 8E1 shows a container with a saturated solution containing approximately 0.06% mercury sulfate. FIG. 8E2 shows a saturated solution containing approximately 0.06% mercury sulfate diluted 10 times with water. FIG. 8E3 shows a saturated solution containing approximately 0.06% mercury sulfate diluted 100 times with water. FIG. 8E4 shows a saturated solution containing approximately 0.06% mercury sulfate diluted a thousand fold. FIG. 8E5 is a control solution containing 5 ml of a saturated solution of mercury sulfate and 0.1 ml of water. When 5 ml of each solution was treated with 0.1 ml of augmented reagent an instantaneous reaction was noted. In contrast, no precipitate formed with the untreated control, which contains 5 ml of the saturated solution of mercury sulfate and 0.1 ml of water.

13. Reaction with Various Soluble Metal Salts

FIGS. 9A to 12D show the results of various concentrations of different soluble metal salts being treated with the augmented solubilized reagent, prepared as in Example 2. FIGS. 9A, 9B, and 9C show the results of reactions of 5 ml of soluble antimony oxide at concentrations of 0.1, 0.01, and 0.001 wt %, respectively, with 0.1 ml of the augmented solubilized reagent, and FIG. 9D show a solution of antimony oxide untreated with augmented solubilized reagent. As can be seen, strong intense reactions occurred in FIGS. 9A and 9B, less so in FIG. 9C and none in the control (FIG. 9D), which contains 5 ml of 0.1 wt % soluble antimony oxide and 0.1 ml water.

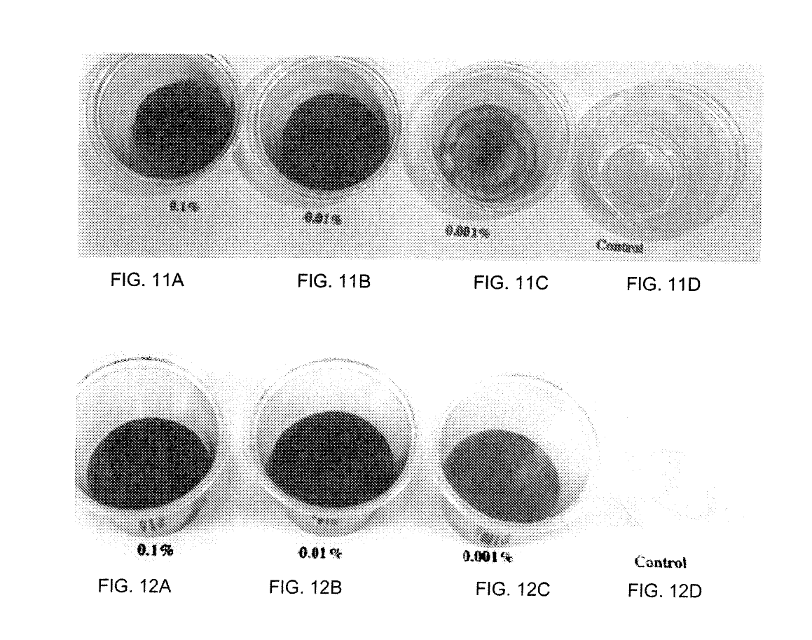

FIGS. 10A-D show the results of various concentrations of chromium sulfate being treated with an aliquot of the augmented reagent (Example 2). Similarly, FIGS. 11-12 show the results of various concentrations of cobalt sulfate and iron sulfate, respectively, being treated with an aliquot of the augmented reagent (prepared as in Example 2). It was noted that strong intense reactions of all the soluble metal salts occur at 0.1 wt % and 0.01 wt %, less intense at 0.001 wt %, and none in the controls (FIGS. 10D, 11D, and 12D), each contains 0.1 ml of water and 5 ml of 0.1 wt % soluble chromium sulfate, 0.1 wt % cobalt sulfate, and 0.1 wt % iron sulfate, respectively.

Based on the above experiments it was noted that the augmented reagent can react with a variety of metal salts at various concentrations (0.1 to 0.001 wt %). It was noted that the reaction was very intense with iron sulfate, cobalt sulfate and antimony oxide and less so with chromium oxide. The augmented reagent therefore can be used effectively when any of the above heavy metals and their metal salts, including lead nitrate is present in a contaminated source. It was also noted that the augmented reagent reacts more rapidly and with a greater intensity as compared to the granular MBS™ slurry, which is used in the current MBS™ technology (see FIG. 2).

In one embodiment, the augmented reagent is ideally suited for conditions that require an immediate remediation in which the contaminants will not be recurring. An example would be air filters and heavy metal disposal bags. The augmented reagent can also be used in conjunction with slow release forms of MBS™ (e.g., plugs, chips and/or spikes). In such a fashion, the contaminated area would be remediated with dispatch and continue to bind future contaminating metals which would be rendered nonhazardous.

The reagent also can be used in situations involving heavy metal contaminated liquids, i.e. mine run-off water, holding ponds, and chemical spills. In one embodiment, the augmented reagent is used so that the resulting reaction does not significantly add to the total bulk of the recovered metal. Once the metal is bound as the sulfide, it can be readily collected and the metal recovered by conventional smelting processes.

What is claimed is:

1. A solubilized, heavy metal binding reagent, comprising:
an isolated supernatant of an aqueous mixture of alkali metal/alkaline earth metal carbonate, alkali metal/alkaline earth metal sulfide, and triple super phosphate.

2. The reagent of claim 1, wherein the aqueous mixture is a saturated or supersaturated solution.

3. The reagent of claim 1, wherein the aqueous mixture is a slurry.

4. The reagent of claim 1 further comprising an additional agent selected from the group consisting of calcium sulfide, calcium phosphate, calcium hydroxide, calcium carbonate, calcium oxide, magnesium sulfide, magnesium phosphate, magnesium hydroxide, magnesium carbonate, magnesium oxide, mixed calcium- and magnesium-containing carbonates and phosphates, apatite, di-calcium hydrogen phosphate, calcium di-hydrogen phosphate, triple super phosphate, dolomite, phosphoric acid and its salts, calcium-X-phosphates (where X is a metal ion), alkaline earth silicates, hydrated silica, hydrated alumina, and metal absorbing clays.

5. The reagent of claim 1, wherein the alkali metal/alkaline earth metal carbonate is calcium carbonate and the alkali metal/alkaline earth metal sulfide is calcium sulfide.

6. The reagent of claim 5, wherein the calcium carbonate, calcium sulfide, and triple super phosphate in the isolated supernatant are present in a weight ratio of about 0.01:0.27:10.00.

7. The reagent of claim 6, wherein the calcium carbonate is present at a concentration of 0.0105 wt %.

8. The reagent of claim 6, wherein the calcium sulfide is present at a concentration of 0.27 wt %.

9. The reagent of claim 6, wherein the triple super phosphate is present at a concentration of 10 wt %.

10. The reagent of claim 5, wherein the calcium carbonate, calcium sulfide, and triple super phosphate in the isolated supernatant are present in a weight ratio of about 0.02:0.34:10.50.

11. The reagent of claim 10, wherein the calcium carbonate is present at a concentration of 0.017 wt %.

12. The reagent of claim 10, wherein the calcium sulfide is present at a concentration of 0.34 wt %.

13. The reagent of claim 10, wherein the triple super phosphate is present at a concentration of 10.5 wt %.

14. The reagent of claim 1, wherein the solubilized reagent is capable of reacting substantially instantaneously with a 2 wt % solution lead nitrate.

15. The reagent of claim 1, wherein the solubilized reagent has a pH of about 11.5.

16. The reagent of claim 1, wherein the solubilized reagent has a specific gravity of about 1.02.

17. The reagent of claim 1, wherein the solubilized reagent has a refractive index of about 2.6

18. The reagent of claim 10, wherein the solubilized reagent has a pH of about 12.

19. The reagent of claim 10, wherein the solubilized reagent has a specific gravity of about 1.02.

20. The reagent of claim 10, wherein the solubilized reagent has a refractive index of about 2.1

21. A solubilized, heavy metal binding reagent, comprising:
an isolated supernatant of a saturated or supersaturated aqueous solution of alkali metal/alkaline earth metal carbonate, alkali metal/alkaline earth metal sulfide, and triple super phosphate, wherein the isolated supernatant has about 10 wt % or more triple super phosphate.

22. The solubilized reagent of claim 21, wherein the solubilized reagent has a pH of about 12

23. The solubilized reagent of claim 21, wherein the solubilized reagent has a specific gravity of about 1.02.

24. The solubilized reagent of claim 21, wherein the isolated supernatant has a weight ratio of alkali metal/alkaline earth metal carbonate, alkali metal/alkaline earth metal sulfide, and triple super phosphate at about 0.01:0.27:10.00.

25. The solubilized reagent of claim 21, wherein the isolated supernatant has a weight ratio of alkali metal/alkaline earth metal carbonate, alkali metal/alkaline earth metal sulfide, and triple super phosphate at about 0.02:0.34:10.50.

26. The solubilized reagent of claim 21, wherein the solubilized reagent is capable of reacting substantially instantaneously with a 2 wt % solution of lead nitrate.

27. A solubilized, heavy metal binding reagent prepared by a process comprising the steps of:
a) isolating a first supernatant of an aqueous mixture comprising alkali metal/alkaline earth metal carbonate, alkali metal/alkaline earth metal sulfide, and triple super phosphate;
b) isolating a second supernatant of a saturated or supersaturated solution of alkali metal/alkaline earth metal carbonate;
c) isolating a third supernatant of a saturated or supersaturated solution of alkali metal/alkaline earth metal sulfide;
d) isolating a fourth supernatant of a saturated or supersaturated solution of triple super phosphate;
f) combining the first, second, third, and fourth supernatants to form a final solution.

28. The solubilized reagent prepared by the process of claim 27, further comprising mixing the second, third, and fourth supernatants to obtain a mixture of supernatants prior to combining with the first supernatant.

29. The solubilized reagent prepared by the process of claim 27, wherein the alkali metal/alkaline earth metal carbonate is calcium carbonate and the alkali metal/alkaline earth metal sulfide is calcium sulfide.

30. The solubilized reagent prepared by the process of claim 27, wherein the alkali metal/alkaline earth metal carbonate is calcium carbonate, and the alkali metal/alkaline earth metal sulfide is calcium sulfide, and further comprising diluting the fourth supernatant with water at a volume ratio of 1:20 and mixing the second, third, and fourth supernatants at a volume ratio of about 2:2:1 to obtain a mixture of supernatants prior to combining with the first supernatant.

31. A method of making a solubilized heavy metal binding reagent comprising:
forming an aqueous mixture of alkali metal/alkaline earth metal carbonate, alkali metal/alkaline earth metal sulfide, and triple super phosphate;
forming a supernatant by allowing the slurry to settle; and
collecting the first supernatant.

32. The method of claim 31 further comprising filtering the first supernatant to obtain a filtrate and collecting the filtrate.

33. The method of claim 31, wherein a weight amount ratio of the alkali metal/alkaline earth metal carbonate to the alkali metal/alkaline earth metal sulfide in the slurry is at about 1:1.

34. The method of claim 31, wherein a weight ratio of triple super phosphate to the alkali metal/alkaline earth metal sulfide in the slurry is less than or equal 3:8.5

35. The method of claim 31, wherein a weight ratio of triple super phosphate to the alkali metal/alkaline earth metal sulfide in the slurry is less than or equal 3:8

36. The method of claim 31, wherein a weight amount ratio of the alkali metal/alkaline earth metal carbonate, the alkali metal/alkaline earth metal sulfide powder, and the triple super phosphate in the first supernatant is at about 0.01:0.27:10.00.

37. The method of claim 31, wherein the aqueous slurry comprising a mixture of the alkali metal/alkaline earth metal carbonate, the alkali metal/alkaline earth metal sulfide powder, and the triple super phosphate, and water at a weight ratio of about 1:2.

38. The method of claim 31 further comprising:
forming a second supernatant of a saturated or supersaturated solution of alkali metal/alkaline earth metal carbonate, alkali metal/alkaline earth metal sulfide, and triple super phosphate; and
mixing the second supernatant with the first supernatant to form a final supernatant mixture.

39. The method of claim 31, wherein the forming of the second supernatant comprising:
forming a metal carbonate supernatant of a saturated or supersaturated solution of alkali metal/alkaline earth metal carbonate, a metal sulfide supernatant of a saturated or supersaturated solution of alkali metal/alkaline earth metal sulfide, and a phosphate supernatant of a saturated or supersaturated solution of triple super phosphate; and
mixing the metal carbonate, metal sulfide, and phosphate supernatants together to form a mixture;
allowing the mixture to settle to form a second supernatant; and
isolating the second supernatant.

40. The method of claim 39 further comprising:
diluting the phosphate supernatant with water at a weight ratio of about 1:20 prior to forming the mixture.

41. The method of claim 38, wherein the second supernatant has about 105 ppm alkali metal/alkaline earth metal carbonate by weight.

42. The method of claim 38, wherein the second supernatant has about 0.27 wt % alkali metal/alkaline earth metal sulfide.

43. The method of claim 38, wherein the second supernatant has about 10 wt % triple super phosphate.

44. The method of claim 38, wherein the final supernatant mixture has a weight ratio of alkali metal/alkaline earth metal carbonate, alkali metal/alkaline sulfide, and triple super phosphate at about 0.02:0.34:10.50.

45. The method of claim 31 further comprising contacting the final supernatant mixture with a media that may be contaminated with heavy metals.

46. The method of claim 45, wherein the media is a surface.

47. The method of claim 45, wherein the media is a water source.

48. The method of claim 45, wherein the aqueous mixture comprises a slurry.
